(19) United States
(12) Patent Application Publication
(10) Pub. No.: US 2021/0153716 A1
(43) Pub. Date: May 27, 2021

(54) TABLEWARE WASHING DEVICE AND METHOD OF WASHING TABLEWARES

(71) Applicant: HONG-FAN WEI, TAIPEI CITY (TW)

(72) Inventor: HONG-FAN WEI, TAIPEI CITY (TW)

(21) Appl. No.: 17/104,279

(22) Filed: Nov. 25, 2020

Related U.S. Application Data
(60) Provisional application No. 62/939,716, filed on Nov. 25, 2019.

(30) Foreign Application Priority Data
Jun. 23, 2020 (CN) 202010582354.7

(51) Int. Cl. A47L 15/42; A47L 15/00; A47L 15/46; A47L 15/16

(52) U.S. Cl. CPC A47L 15/4295; A47L 15/0028; A47L 15/4285; A47L 15/16; A47L 15/46

(57) ABSTRACT

A tableware washing device and a method of washing tablewares are provided. The tableware washing device includes: a casing including a first accommodating space, which is used for accommodating at least one tableware for performing a washing process, a carrying module disposed in the casing, a control module, a first cleaning module disposed on an inner side of the casing and electrically connected to the control module, and a first image capture module electrically connected to the control module and disposed in the casing. The first cleaning module includes a plurality of first cleaning units that respectively provide a plurality of cleaning jets to clean the at least one tableware. The control module determines whether or not the at least one tableware is clean through a plurality of first cleaning procedure image informations captured by the first image capture module.

### CROSS-REFERENCE TO RELATED PATENT APPLICATION

This application claims the benefit of priority to China Patent Application No. 202010582354.7, filed on Jun. 23, 2020 in People's Republic of China. The entire content of the above identified application is incorporated herein by reference.

This application claims priority to the U.S. Provisional Patent Application Ser. No. 62/939,716 filed on Nov. 25, 2019, which application is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a tableware washing device and a method of washing tablewares, and more particularly to a tableware washing device and a method of washing tablewares that saves power and water.

### BACKGROUND OF THE DISCLOSURE

Conventional dishwashers are usually only able to perform predetermined washing processes, and the predetermined washing processes are unable to be properly adjusted according to the quantity of tablewares, thereby wasting an abundant amount of power and water.

Therefore, it has become an important issue in the industry to provide a tableware washing device that can adjust the washing processes according to the quantity of tablewares.

### SUMMARY OF THE DISCLOSURE

In response to the above-referenced technical inadequacies, the present disclosure provides a tableware washing device and a method of washing tablewares.

In one aspect, the present disclosure provides a tableware washing device including a casing having a first accommodating space that is used to accommodate at least one tableware to perform a washing process, a carrying module disposed in the casing, a control module, a first cleaning module disposed on an inner side of the casing, and a first image capture module electrically connected to the control module and disposed in the casing. The first cleaning module is electrically connected to the control module and includes a plurality of first cleaning units. The first cleaning units respectively provide a plurality of cleaning jets to clean the at least one tableware. The control module determines whether or not the at least one tableware is clean through a plurality of first cleaning procedure image informations captured by the first image capture module.

In another aspect, the present disclosure provides a method of washing tablewares used to clean at least one tableware. The method includes: heating liquid in a first tank; heating liquid in a second tank; capturing a cleaning procedure image information of the at least one tableware before the at least one tableware is cleaned; providing a plurality of cleaning jets for cleaning according to the cleaning procedure image information of the at least one tableware before cleaning, a weight of the at least one tableware, or a volume ratio thereof; capturing another cleaning procedure image information of the at least one tableware after the at least one tableware is cleaned; and determining whether or not the at least one tableware is clean.

One of the beneficial effects of the tableware washing device of the present disclosure is that the cleaning procedure can be adjusted according to the amount of the tablewares that are to be cleaned, so as to effectively save power and water.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a schematic view of a tableware washing device in a first embodiment of the present disclosure.

FIG. 2 is a cross-sectional schematic view of the tableware washing device in the first embodiment of the present disclosure.

FIG. 3 is a schematic view showing how a first image capture module, a second image capture module, a first cleaning module, and a second cleaning module are arranged in the first embodiment of the present disclosure.

FIG. 4 is a functional block diagram of the tableware washing device in the first embodiment of the present disclosure.

FIG. 5 is a flowchart of a method of washing tablewares in a second embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

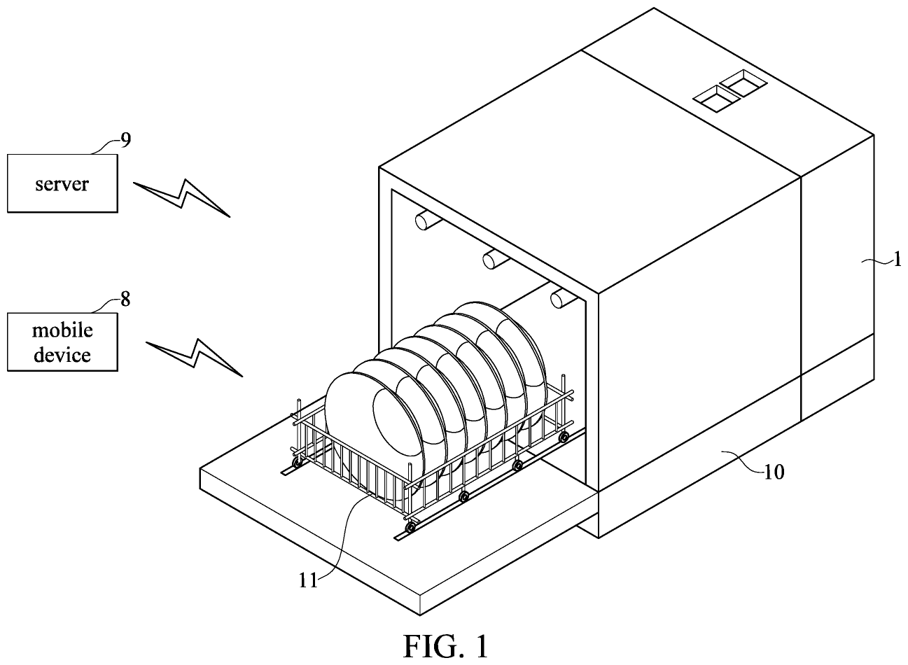

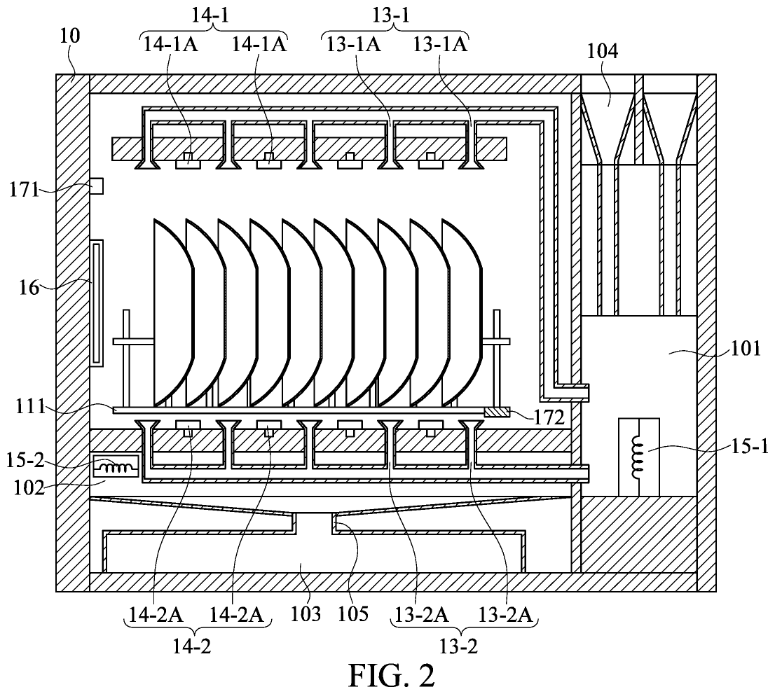

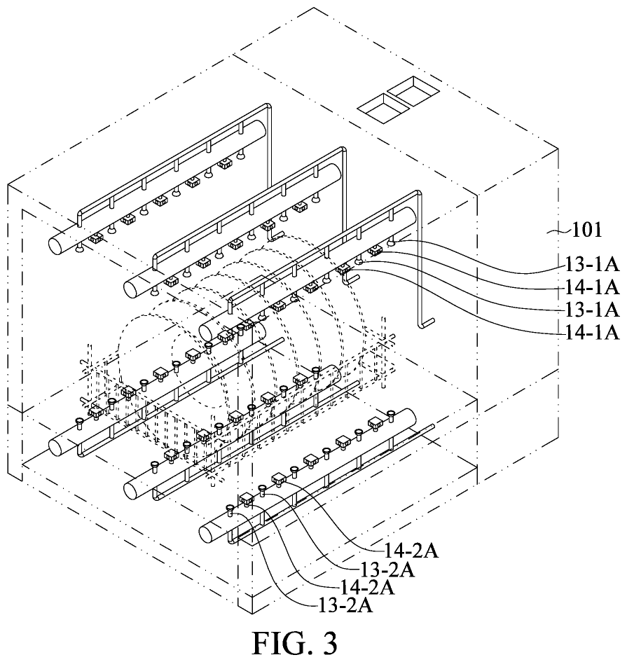

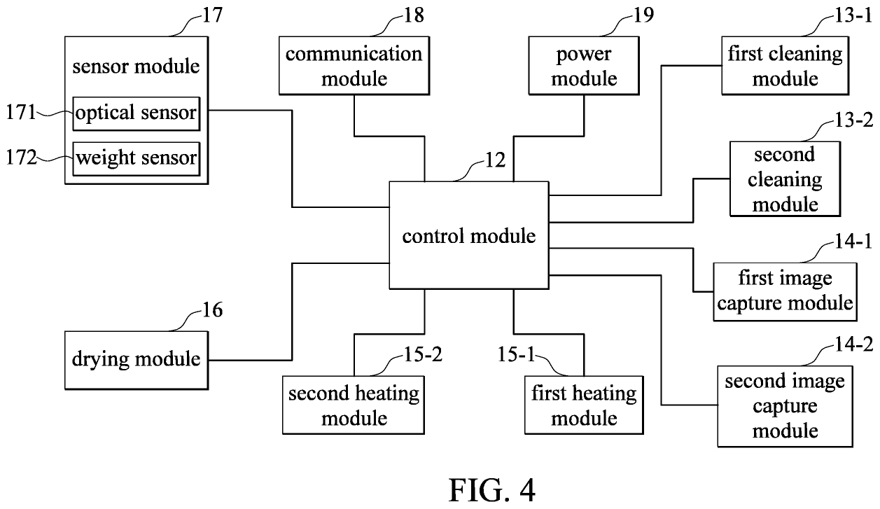

References are made to FIG. 1, FIG. 2, FIG. 3, and FIG. 4. FIG. 1 is a schematic view of a tableware washing device in a first embodiment of the present disclosure. FIG. 2 is a cross-sectional schematic view of the tableware washing device in the first embodiment of the present disclosure. FIG. 3 is a schematic view showing how a first image capture module, a second image capture module, a first cleaning module, and a second cleaning module are arranged in the first embodiment of the present disclosure. FIG. 4 is a functional block diagram of the tableware washing device in the first embodiment of the present disclosure.

The tableware washing device 1 includes a casing 10, a carrying module 11, a control module 12, a first cleaning module 13-1, a second cleaning module 13-2, a first image capture module 14-1, a second image capture module 14-2, a first heating module 15-1, a second heating module 15-2, a drying module 16, a sensor module 17, a communicative module 18, and a power module 19.

The casing 10 includes a first accommodating space which is used to accommodate at least one tableware, such that a washing process can be performed.

The carrying module 11, the control module 12, the first cleaning module 13-1, the second cleaning module 13-2, the first image capture module 14-1, the second image capture module 14-2, the first heating module 15-1, the second heating module 15-2, the drying module 16, the sensor module 17, the communicative module 18, and the power module 19 are disposed in the casing 10.

The carrying module 11 includes a carrying tray 111. The carrying tray 111 of the carrying module 11 is fixedly disposed in the casing 10. In another embodiment, the carrying module 11 can include a slide rail (not shown in the figures), and the carrying tray 111 can be movably disposed on the slide rail (not shown in the figures).

The control module 12 is electrically connected to the first cleaning module 13-1, the second cleaning module 13-2, the first image capture module 14-1, the second image capture module 14-2, the first heating module 15-1, the second heating module 15-2, the drying module 16, the sensor module 17, the communicative module 18, and the power module 19.

The first image capture module 14-1 and the second image capture module 14-2 are both waterproof camera modules, which are used to capture an image of the at least one tableware, e.g., bowls, plates, forks, knives, or chopsticks, disposed on the carrying tray 111 of the carrying module 11.

The first cleaning module 13-1 is disposed on an inner side of the casing 10. In this embodiment, the first cleaning module 13-1 is disposed on an upper half of the inner side of the casing 10, and the first cleaning module 13-1 provides a plurality of cleaning jets from above the at least one tableware to wash the at least one tableware.

In this embodiment, the second cleaning module 13-2 is disposed below the carrying tray 111 of the carrying module 11, and the second cleaning module 13-2 provides another plurality of cleaning jets from below the at least one tableware to wash the at least one tableware. The first cleaning module 13-1 includes a plurality of first cleaning units 13-1A. The first cleaning units 13-1A are electrically connected to the control module 12, and each of the first cleaning units 13-1A receives one of a plurality of first washing control signals, so as to provide one of the cleaning jets to wash the at least one tableware.

The second cleaning module 13-2 includes a plurality of second cleaning units 13-2A. The second cleaning units 13-2A are electrically connected to the control module 12, and each of the second cleaning units 13-2A receives one of a plurality of second washing control signals, so as to provide one of the another cleaning jets to wash the at least one tableware.

The first image capture module 14-1 is electrically connected to the control module 12 and disposed in the casing 10. The first image capture module 14-1 includes a plurality of first image capture units 14-1A. The control module 12 determines whether or not the at least one tableware is clean through a plurality of first cleaning procedure image informations captured by the first image capture module 14-1. The first image capture module 14-1 captures the first cleaning procedure image informations before a cleaning of the at least one tableware, and then the control module 12 determines a degree of dirtiness of the at least one tableware according to the first cleaning procedure image informations before the cleaning of the at least one tableware. During the cleaning procedure, the first image capture module 14-1 also captures the first cleaning procedure image informations to adjust the cleaning procedure. After the cleaning procedure is confirmed to be completed, the first image capture module 14-1 captures the first cleaning procedure image informations after the cleaning of the at least one tableware.

In this embodiment, the first image capture units 14-1A of the first image capture module 14-1 are respectively disposed on a side of each of the first cleaning units 13-1A of the first cleaning module 13-1. In this embodiment, each of the first cleaning units 13-1A is arranged with one of the first image capture units 14-1A on the side. The first cleaning units 13-1A are adopted in order to thoroughly clean the at least one tableware disposed on the carrying module 11 through washing the at least one tableware from different angles, and the first image capture units 14-1A are adopted to capture a plurality of cleaning procedure image informations of the at least one tableware from different angles, so as to determine whether or not the at least one tableware is clean.

The second image capture module 14-2 is electrically connected to the control module 12 and disposed in the casing 10. The second image capture module 14-2 includes a plurality of second image capture units 14-2A. The control module 12 determines whether or not the at least one tableware is clean through a plurality of second cleaning procedure image informations captured by the second image capture module 14-2. The second image capture module 14-2 captures the second cleaning procedure image informations before the cleaning of the at least one tableware, and then the control module 12 determines the degree of dirtiness of the at least one tableware according to the second cleaning procedure image informations before the cleaning of the at least one tableware. During the cleaning procedure, the second image capture module 14-2 also captures the second cleaning procedure image informations to adjust the cleaning procedure. After the cleaning procedure is confirmed to be completed, the second image capture module 14-2 captures the second cleaning procedure image informations after the cleaning of the at least one tableware.

In this embodiment, the second image capture units 14-2A of the second image capture module 14-2 are respectively disposed on a side of each of the second cleaning units 13-2A of the second cleaning module 13-2. In this embodiment, each of the second cleaning units 13-2A is arranged with one of the second image capture units 14-2A on the side. The second cleaning units 13-2A are adopted in order to thoroughly clean the at least one tableware disposed on the carrying module 11 through washing the at least one tableware from different angles, and the second image capture units 14-2A are adopted to capture a plurality of cleaning procedure image informations of the at least one tableware from different angles, so as to determine whether or not the at least one tableware is clean.

The first cleaning module 13-1 provides the cleaning jets from above the at least one tableware to wash the at least one tableware. The second cleaning module 13-2 provides the another cleaning jets from below the at least one tableware to wash the at least one tableware. Similarly, the first image capture module 14-1 captures the first cleaning procedure image informations from above the at least one tableware, and the second image capture module 14-2 captures the second cleaning procedure image informations below the at least one tableware. In addition, the first image capture module 14-1 and the second image capture module 14-2 are both image capture modules that are highly waterproof.

The casing 10 includes a first tank 101, a second tank 102, a third tank 103, and a detergent injection tank 104. The first tank 101 is disposed on one side of the casing 10 for receiving a clean water source. The second tank 102 is disposed on the bottom side of the casing 10. The third tank 103 is disposed below the second tank 102 and connected to the second tank 102 via a communication module 105. The detergent injection tank 104 is disposed on one side of the casing 10. In this embodiment, the detergent injection tank 104 may be in spatial communication with the first tank 101 or the second tank 102. That is, one of the first tank 101 and the second tank 102 stores the clean water source, and the other tank is used to mix the clean water and the detergent to provide diluted detergent. In this embodiment, the detergent in the detergent injection tank 104 is mixed with the clean water source in the first tank 101 to produce a diluted detergent. The first cleaning module 13-1 sprays the diluted detergent in the first tank 101 onto the at least one tableware. After the at least one tableware is soaked for a period of time, the clean water source of the second tank 102 is sprayed and used for cleaning After the at least one tableware is cleaned, the communication module 105 receives a control signal and opens, so that sewage and residues in the second tank 102 flow to the third tank 103 to be discharged to the outside.

In addition, the communication module 105 includes a switch (not shown in the figures) and a waste storage bag (not shown in the figures). After receiving the control signal from the control module 12, the switch (not shown in the figures) of the communication module 105 is turned on to allow the sewage and the residues to flow through the waste storage bag (not shown in the figures), and the sewage then flows into the third tank. 103.

In another embodiment, both the first tank 101 and the second tank 102 can provide the clean water source. The detergent injection tank 104 can include an individual nozzle to spray the detergent onto the at least one tableware, and then clean the at least one tableware with the clean water source.

In this embodiment, the first heating module 15-1 and the second heating module 15-2 are respectively disposed in the first tank 101 and the second tank 102, so as to heat liquid in the first tank 101 and liquid in the second tank 102, respectively. The first heating module 15-1 and the second heating module 15-2 are each electric heaters.

The tableware washing device 1 further includes a drying module 16 for drying the at least one tableware that is cleaned. The drying module 16 is arranged inside the casing 10 and on one side of the carrying module 11. The drying module 16 includes a fan (not shown in the figures) and a heater (not shown in the figures). The heater (not shown in the figures) is used to heat up air in the casing 10, and the fan (not shown in the figures) provides an air convection driving force to dry the at least one tableware.

The sensor module 17 of the tableware washing device 1 optimizes the cleaning procedure of the at least one tableware to save power and water resources. The tableware washing device 1 adjusts the cleaning procedure according to one of methods or a combination thereof which will be further described in the following (i.e., a weight and a volume ratio). The sensor module 17 includes an optical sensor 171 and a weight sensor 172.

Firstly, the optical sensor 171 is disposed on the inner side of the casing 10 to detect a volume ratio between the at least one tableware arranged on the carrying module 11 and an internal space of the casing 10.

The control module 12 provides a corresponding cleaning procedure according to the volume ratio of the at least one tableware and the internal space of the casing 10, so as to drive the first cleaning module 13-1 and the second cleaning module 13-2 to provide the cleaning jets and the another cleaning jets to clean the at least one tableware. That is to say, when the volume ratio is relatively large (a larger quantity of tablewares), the control module 12 drives the first cleaning module 13-1 and the second cleaning module 13-2 to provide the cleaning jets and the another cleaning jets for the cleaning procedure for a relatively longer duration. When the volume ratio is relatively small (a fewer quantity of tablewares), the control module 12 drives the first cleaning module 13-1 and the second cleaning module 13-2 to provide the cleaning jets and the another cleaning jets for the cleaning procedure for a relatively shorter duration.

The weight sensor 172 is disposed on one side of the carrying module 11, that is, below the carrying module 11, and the weight sensor 172 is used to detect a weight of the carrying tray 111 of the carrying module 11 and a weight of the at least one tableware carried by the carrying module 11.

The control module 12 provides a corresponding cleaning procedure according to the weight of the at least one tableware and the carrying module 11, so as to drive the first cleaning module 13-1 and the second cleaning module 13-2 to provide the cleaning jets and the another cleaning jets to clean the at least one tableware. That is to say, when the weight is relatively large (a larger quantity of tablewares), the control module 12 drives the first cleaning module 13-1 and the second cleaning module 13-2 to provide the cleaning jets and the another cleaning jets for the cleaning procedure for a relatively longer duration. When the weight is relatively small (a fewer quantity of tablewares), the control module 12 drives the first cleaning module 13-1 and the second cleaning module 13-2 to provide the cleaning jets and the another cleaning jets for the cleaning procedure for a relatively shorter duration.

According to the above, the control module 12 of the tableware washing device 1 can adjust the cleaning procedure according to the weight, the volume ratio or a combination thereof. Furthermore, the control module 12 of the tableware washing device 1 can provide the cleaning jets and the another cleaning jets for cleaning the at least one tableware according to the cleaning procedure image informations before the cleaning of the at least one tableware, the weight of the at least one tablewares, the volume ratio, or a combination thereof.

In addition, after the cleaning is completed, the first image capture module 14-1 and the second image capture module 14-2 capture the first cleaning procedure image informations and the second cleaning procedure image informations after the cleaning of the at least one tableware, such that the first cleaning procedure image informations and the second cleaning procedure image informations captured after the cleaning of the at least one tableware are compared with those captured before the cleaning of the at least one tableware.

At this time, the control module 12 respectively identifies original patterns, gloss after the cleaning, and oil stains on the at least one tableware. The control module 12 can simultaneously use the first cleaning procedure image informations and the second cleaning procedure image informations during the cleaning for comparison. When the first cleaning module 13-1 and the second cleaning module 13-2 provide relatively strong cleaning jets for cleaning, and there are still patterns on the at least one tableware which cannot be washed away, the patterns can be determined as the original patterns of the at least one tableware. In addition, oil stains are generally more irregular, having darker colors, and can be easily washed away with hot water. These features can be analyzed and identified through image recognition.

In addition, the first cleaning module 13-1 and the second cleaning module 13-2 can be a single, integral cleaning module. Furthermore, the quantity of the first cleaning units 13-1A of the first cleaning module 13-1 and the quantity of the second cleaning units 13-2A of the second cleaning module 13-2 can be adjusted according to the size of the casing 10.

Furthermore, the tableware washing device 1 can further include a storage module (not shown in the figures). In addition, the tableware washing device 1 can further include a storage module (not shown in the figures), which is used to store a variety of parameters of the tableware washing device 1. The storage module can be a flash memory, a read-only memory, a programmable read-only memory, an electrically rewritable read-only memory, an erasable programmable read-only memory, or an electrically erasable programmable read-only memory.

The power module 19 may be an alternating current to direct current (AC-DC) voltage converter or a DC-DC voltage converter. The communicative module 18 is electrically connected to the control module 12. The tableware washing device 1 is communicatively connected to a server 9 through the communicative module 18, so as to receive or transmit at least one cleaning program or a plurality of cleaning data.

The tableware washing device 1 can be communicatively connected with the server 9 or a mobile device 8 through the communicative module 18. The user can use an application (APP) in the mobile device 8 to be communicatively connected with the communicative module 18 of the tableware washing device 1 to send at least one cleaning setting value. In this embodiment, the communicative module 18 includes a wired communication unit (not shown in the figures) and a wireless communication unit (not shown in the figures). The wired communication unit (not shown in the figures) can be arranged independently to be communicatively connected with the server 9, so as to receive a control signal or data in a database (not shown in the figures) of the server 9. The wireless communication unit (not shown in the figures) can be a WI-FI® communication unit, a BLUETOOTH® communication unit, a ZIGBEE® communication unit, a LoRa communication unit, a Sigfox communication unit, or an NB-IoT communication unit.

### Second Embodiment

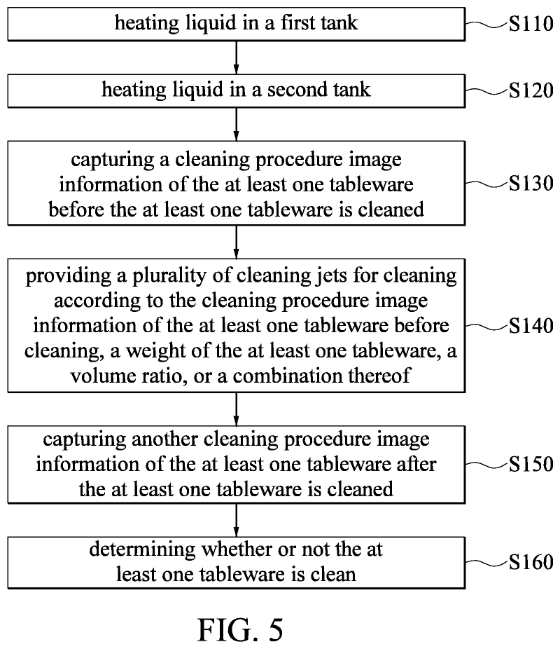

Reference is made to FIG. 5, which is a flowchart of a method of washing tablewares in a second embodiment of the present disclosure. The method of washing tablewares can be adapted to the tableware washing device 1 in the first embodiment, and functions and structures thereof will not be reiterated herein.

The method of washing tablewares that is adapted to clean at least one tableware includes the following steps:

heating liquid in a first tank (step S110);

heating liquid in a second tank (step S120);

capturing a cleaning procedure image information of the at least one tableware before the at least one tableware is washed (step S130);

providing a plurality of cleaning jets for washing according to the cleaning procedure image information of the at least one tableware before washing, a weight of the at least one tableware, a volume ratio, or a combination thereof (step S140);

capturing another cleaning procedure image information of the at least one tableware after the at least one tableware is washed (step S150); and

determining whether or not the at least one tableware is cleaned (step S160).

In step S110 and step S120, the first heating module 15-1 and the second heating module 15-2 respectively heat the liquid in the first tank 101 and the liquid in the second tank 102. The first tank 101 is disposed on one side of the casing 10 for receiving a clean water source. The second tank 102 is disposed on the bottom side of the casing 10. The third tank 103 of the casing 10 is disposed below the second tank 102 and connected to the second tank 102 via the communication module 105. The detergent injection tank 104 is disposed on one side of the casing 10. In this embodiment, the detergent injection tank 104 may be in spatial communication with the first tank 101 or the second tank 102.

That is, one of the first tank 101 and the second tank 102 stores the clean water source, and the other tank is used to mix the clean water and the detergent together to provide diluted detergent. In this embodiment, the detergent in the detergent injection tank 104 is mixed with the clean water source in the first tank 101 to produce a diluted detergent. That is to say, in this embodiment, the liquid in the first tank 101 is the diluted detergent, and the liquid in the second tank 102 is the clean water source. In another embodiment, the liquid in the first tank 101 is the clean water source, and the liquid in the second tank 102 is the diluted detergent. Furthermore, the clean water source and the diluted detergent that are heated can easily clean the oil stains on the at least one tableware more effectively.

In step S130 and step S140, the first image capture module 14-1 is electrically connected to the control module 12 and disposed in the casing 10. The first image capture module 14-1 includes a plurality of first image capture units 14-1A. The control module 12 determines whether or not the at least one tableware is clean through a plurality of first cleaning procedure image informations (i.e., more than one of the cleaning procedure image information can be captured) captured by the first image capture module 14-1. The first image capture module 14-1 captures the first cleaning procedure image informations before a cleaning of the at least one tableware, and then the control module 12 determines a degree of dirtiness of the at least one tableware according to the first cleaning procedure image informations before the cleaning of the at least one tableware. During the cleaning procedure, the first image capture module 14-1 also captures the first cleaning procedure image informations to adjust the cleaning procedure. After the cleaning procedure is confirmed to be completed, the first image capture module 14-1 captures the first cleaning procedure image informations after the cleaning of the at least one tableware.

In this embodiment, the first image capture units 14-1A of the first image capture module 14-1 are respectively disposed on a side of each of the first cleaning units 13-1A of the first cleaning module 13-1. In this embodiment, each of the first cleaning units 13-1A is arranged with one of the first image capture units 14-1A on the side. The first cleaning units 13-1A are adopted in order to thoroughly clean the at least one tableware disposed on the carrying module 11 through washing the at least one tableware from different angles, and the first image capture units 14-1A are adopted to capture a plurality of cleaning procedure image informations of the at least one tableware from different angles, so as to determine whether or not the at least one tableware is clean.

The second image capture module 14-2 is electrically connected to the control module 12 and disposed in the casing 10. The second image capture module 14-2 includes a plurality of second image capture units 14-2A. The control module 12 determines whether or not the at least one tableware is clean through a plurality of second cleaning procedure image informations (i.e., more than one of the another cleaning procedure image information can be captured) captured by the second image capture module 14-2. The second image capture module 14-2 captures the second cleaning procedure image informations before the cleaning of the at least one tableware, and then the control module 12 determines the degree of dirtiness of the at least one tableware according to the second cleaning procedure image informations before the cleaning of the at least one tableware. During the cleaning procedure, the second image capture module 14-2 also captures the second cleaning procedure image informations to adjust the cleaning procedure. After the cleaning procedure is confirmed to be completed, the second image capture module 14-2 captures the second cleaning procedure image informations after the cleaning of the at least one tableware.

In this embodiment, the second image capture units 14-2A of the second image capture module 14-2 are respectively disposed on a side of each of the second cleaning units 13-2A of the second cleaning module 13-2. In this embodiment, each of the second cleaning units 13-2A is arranged with one of the second image capture units 14-2A on the side. The second cleaning units 13-2A are adopted in order to thoroughly clean the at least one tableware disposed on the carrying module 11 through washing the at least one tableware from different angles, and the second image capture units 14-2A are adopted to capture a plurality of cleaning procedure image informations of the at least one tableware from different angles, so as to determine whether or not the at least one tableware is clean.

The first cleaning module 13-1 provides the cleaning jets from above the at least one tableware to wash the at least one tableware. The second cleaning module 13-2 provides the another cleaning jets from below the at least one tableware to wash the at least one tableware. Similarly, the first image capture module 14-1 captures the first cleaning procedure image informations from above the at least one tableware, and the second image capture module 14-2 captures the second cleaning procedure image informations below the at least one tableware. In addition, the first image capture module 14-1 and the second image capture module 14-2 are both image capture modules that are highly waterproof.

The optical sensor 171 is disposed on the inner side of the casing 10 to detect a volume ratio between the at least one tableware arranged on the carrying module 11 and an internal space of the casing 10.

The control module 12 provides a corresponding cleaning procedure according to the volume ratio of the at least one tableware and the internal space of the casing 10, so as to drive the first cleaning module 13-1 and the second cleaning module 13-2 to provide the cleaning jets and the another cleaning jets to clean the at least one tableware. That is to say, when the volume ratio is relatively large (a larger quantity of tablewares), the control module 12 drives the first cleaning module 13-1 and the second cleaning module 13-2 to provide the cleaning jets and the another cleaning jets for the cleaning procedure for a relatively longer duration. When the volume ratio is relatively small (a fewer quantity of tablewares), the control module 12 drives the first cleaning module 13-1 and the second cleaning module 13-2 to provide the cleaning jets and the another cleaning jets for the cleaning procedure for a relatively shorter duration.

The weight sensor 172 is disposed on one side of the carrying module 11. That is, below the carrying module 11, and the weight sensor 172 is used to detect a weight of the carrying tray 111 of the carrying module 11 and a weight of the at least one tableware carried by the carrying module 11.

The control module 12 provides a corresponding cleaning procedure according to the weight of the at least one tableware and the carrying module 11, so as to drive the first cleaning module 13-1 and the second cleaning module 13-2 to provide the cleaning jets and the another cleaning jets to clean the at least one tableware. That is to say, when the weight is relatively large (a larger quantity of tablewares), the control module 12 drives the first cleaning module 13-1 and the second cleaning module 13-2 to provide the cleaning jets and the another cleaning jets for the cleaning procedure for a relatively longer duration. When the weight is relatively small (a fewer quantity of tablewares), the control module 12 drives the first cleaning module 13-1 and the second cleaning module 13-2 to provide the cleaning jets and the another cleaning jets for the cleaning procedure for a relatively shorter duration.

According to the above, the control module 12 of the tableware washing device 1 can adjust the cleaning procedure according to the weight, the volume ratio or a combination thereof. Furthermore, the control module 12 of the tableware washing device 1 can provide the cleaning jets and the another cleaning jets for cleaning the at least one tableware according to the cleaning procedure image informations before the cleaning of the at least one tableware, the weight of the at least one tablewares, the volume ratio, or a combination thereof.

In step S150 and step S160, after the cleaning is completed, the first image capture module 14-1 and the second image capture module 14-2 capture the first cleaning procedure image informations and the second cleaning procedure image informations after the cleaning of the at least one tableware, such that the first cleaning procedure image informations and the second cleaning procedure image informations captured after the cleaning of the at least one tableware are compared with those captured before the cleaning of the at least one tableware.

At this time, the control module 12 respectively identifies original patterns, gloss after the cleaning, and oil stains on the at least one tableware. The control module 12 can simultaneously use the first cleaning procedure image informations and the second cleaning procedure image informations during the cleaning for comparison. When the first cleaning module 13-1 and the second cleaning module 13-2 provide the relatively strong cleaning jets and the relatively strong another cleaning jets for cleaning, and there are still patterns on the at least one tableware which cannot be washed away, the patterns can be determined as the original patterns of the at least one tableware. In addition, oil stains are generally more irregular, having darker colors, and can be easily washed away with hot water. These features can be analyzed and identified through image recognition.

When the control module 12 determines that the at least one tableware is clean, the control module 12 drives the drying module 16 to perform a drying procedure.

### Beneficial Effects of Embodiments

One of the beneficial effects of the tableware washing device of the present disclosure is that the cleaning procedure can be adjusted according to the amount of the tablewares that are to be cleaned, so as to effectively save power and water resources.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A tableware washing device, comprising:
a casing including a first accommodating space that is used to accommodate at least one tableware for performing a washing process;
a carrying module disposed in the casing;
a control module;
a first cleaning module disposed on an inner side of the casing, the first cleaning module being electrically connected to the control module, and the first cleaning module including a plurality of first cleaning units, wherein the first cleaning units respectively provide a plurality of cleaning jets to clean the at least one tableware; and
a first image capture module electrically connected to the control module and disposed in the casing;
wherein the control module determines whether or not the at least one tableware is clean through a plurality of first cleaning procedure image informations captured by the first image capture module.

2. The tableware washing device according to claim 1, wherein the casing includes:
a first tank disposed on one side of the casing, the first tank being used to receive a clean water source;
a second tank disposed on a bottom side of the casing;
a third tank disposed under the second tank, the third tank being connected with the second tank through a communication module; and
a detergent injection tank disposed on another side of the casing;
wherein the detergent injection tank is in spatial communication with the first tank and the second tank.

3. The tableware washing device according to claim 2, wherein the communication module includes a switch and a waste storage bag.

4. The tableware washing device according to claim 2, further comprising a first heating module disposed in the first tank and used for heating up a liquid in the first tank.

5. The tableware washing device according to claim 3, further comprising a second heating module disposed in the second tank and used for heating up a liquid in the second tank.

6. The tableware washing device according to claim 1, further comprising a drying module electrically connected to the control module and used for drying the at least one tableware that is cleaned.

7. The tableware washing device according to claim 1, further comprising a second cleaning module disposed under the carrying module, the second cleaning module being electrically connected to the control module.

8. The tableware washing device according to claim 1, further comprising a sensor module, the sensor module including a weight sensor disposed on a side of the carrying module, wherein the weight sensor is used to detect a weight of the carrying module and a weight of the at least one tableware carried by the carrying module.

9. The tableware washing device according to claim 8, wherein the control module provides a corresponding washing process that drives the first cleaning module to provide the cleaning jets to clean the at least one tableware according to the weight of the carrying module and the weight of the at least one tableware.

10. The tableware washing device according to claim 1, further comprising a sensor module, the sensor module including an optical sensor disposed on an inner side of the casing, wherein the optical sensor is used to detect a volume ratio between the at least one tableware arranged on the carrying module and an internal space of the casing.

11. The tableware washing device according to claim 10, wherein, according to the volume ratio, the control module provides a corresponding washing process that drives the first cleaning module to provide the cleaning jets for cleaning the at least one tableware.

12. The tableware washing device according to claim 1, further comprising a power module electrically connected to the control module, the power module being an alternating current (AC) to direct current (DC) voltage converter or a DC-AC voltage converter.

13. The tableware washing device according to claim 7, further comprising a second image capture module electrically connected to the control module and disposed in the casing, the second image capture module being disposed on a side of the second cleaning module, wherein the control module determines whether or not the at least one tableware is clean through a plurality of second cleaning procedure image informations captured by the second image capture module.

14. The tableware washing device according to claim 1, further comprising a communicative module electrically connected to the control module, wherein the tableware washing device is communicatively connected to a server via the communicative module, and the communicative module is used to receive or transmit at least one cleaning program or a plurality of cleaning data.

15. A method of washing tablewares used to clean at least one tableware, the method comprising:
heating liquid in a first tank;
heating liquid in a second tank;
capturing a cleaning procedure image information of the at least one tableware before the at least one tableware is cleaned;
providing a plurality of cleaning jets for cleaning according to the cleaning procedure image information of the at least one tableware before cleaning, a weight of the at least one tableware, or a volume ratio thereof;
capturing another cleaning procedure image information of the at least one tableware after the at least one tableware is cleaned; and
determining whether or not the at least one tableware is clean.
